(19) United States
(12) Patent Application Publication
(10) Pub. No.: US 2008/0249657 A1
(43) Pub. Date: Oct. 9, 2008

(54) Customized greeting card printing system

(76) Inventors: Lloyd Wendland, Newport Beach, CA (US); John McAvoy, Deerfield, IL (US); Ken Levin, Skokie, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/784,287

(22) Filed: Apr. 6, 2007

(51) Int. Cl. G06F 19/00

(52) U.S. Cl. 700/235

(57) ABSTRACT

A system and method for creating a customized greeting card for a recipient is disclosed. The system includes a computer readable memory, a map database that stores map data pertaining to a plurality of geographic locations. The locations include location-specific indicia. A first processor executable routine obtains map data pertaining to a selected geographic location from a database, and a second processor executable routine displays on a user interface the map data including location-specific indicia for the selected location. A third processor executable routine displays on the user interface an electronic greeting card depicting the selected location, and a fourth processor executable routine enables the user to change the location-specific indicia to a customized indicia to permit the customized indicia to be suitably displayed or presented to a user. The greeting card may be presented to the user electronically or may be printed on a suitable substrate.

### TECHNICAL FIELD

This disclosure relates generally to greeting cards and, more particularly, to a greeting card system and method that enables a user to design, display, send, and/or print a customized greeting card including inserted map information.

### DESCRIPTION OF THE RELATED ART

In the manufacture of greeting cards, it may be desirable to provide certain features that distinguish the greeting cards of one manufacturer from its competitors. For example, greeting cards often include visually appealing or clever artwork, humorous or inspirational sayings, jokes, etc. Consequently, greeting card manufacturers constantly expend resources in an effort to stay ahead of their competition. Moreover, the art of greeting card manufacture is presently expanding in the area of electronic or online selection and design of greeting cards, with many systems enabling the consumer to design and print a custom-created greeting card. Nevertheless, greeting card manufacturers still desire additional attention-grabbing features in order to satisfy consumer demand.

In the unrelated art of map making, it is known to store map information in one or more proprietary databases and to then use this map information to print maps of various types and sizes, such as folding maps, atlases, wall maps, etc. Generally speaking, the map information may be stored in one or more databases according to various geographical areas to which the map information pertains, including for example, various countries, states, regions, cities, counties, etc. The stored map data for any particular geographical area typically includes geographic information and/or location-specific indicia, such as the name of states, regions, cities, towns, streets, highways and roads, train tracks, buildings, points of interest, etc. This map data may also include or represent natural features such as rivers, oceans, seas, beaches, mountains, grade or other cartographic information, etc.

Currently, this map information, once created and stored in the map database(s), is used by a map publisher or other map provider to create and sell maps of various types and sizes. However, in order to obtain access to the stored map data, a person must contact the map publisher or other specialized map provider and must interact with a map provider representative to design and order a map desired by the customer. In particular, the user must work with the representative of the map provider to determine, for example, the desired map area and/or the desired map size. This map design process can be time consuming, tedious for the user, and does not allow the user to either customize the map or view the map prior to printing.

Additionally, this map information, once created and stored in the map database(s), may be used by a software publisher or other software provider to create a software. application with map functionality. However, in order to obtain access to the stored map data, a user typically will have to subscribe to a Web Service that provides access to the data. This Web Service is a software application programming interface (API) that sits on top of the server that holds the map database. This Web Service provides software methods and properties that allow a user to query the map database for map images, address lookups (geocodes), routing directions and spatial searches. In particular, a user will supply the Web Service with a desired address for placement on a map. The Web Service will return a latitude/longitude that can be used in a subsequent map image request. In this subsequent map image request, a user will supply the Web Service with the geocoded latitude/longitude, map scale and map pixel size. The Web Service will then return a digital map image that contains the desired map area.

### BRIEF DESCRIPTION OF THE DRAWINGS

FIG. 1 is a perspective view of an exemplary kiosk incorporating a customized greeting card system;

FIG. 2 is a flow chart illustrating exemplary steps in the creation of a customized greeting card;

FIG. 3 is a block diagram illustrating exemplary components of a customized greeting card design and printing system;

FIG. 4 is an architectural block diagram illustrating components of a customized greeting card design and printing system;

FIG. 5A is a block diagram illustrating additional components of the customized greeting card design and printing system in conjunction with a method by which a user uses the greeting card design and printing system to select, customize and print a greeting card;

FIG. 5B is a block diagram illustrating a web based map engine architecture;

FIG. 6 is an example screen display associated with a user interface that may be used to select a greeting card type and to select a general map area for insertion in the customized greeting card;

FIG. 7 is an example screen display associated with a user interface that may be used to select a greeting card and select an address for the map insert for the greeting card being designed;

FIG. 8 is an example screen display associated with a user interface that may be used to create, view and modify the map insert associated with the customized greeting card;

FIG. 9 is an example screen display associated with a user interface that may be used to view the map insert of the customized greeting card and having a map area being created at the same level of detail or resolution that is to be printed on the final customized greeting card;

FIG. 10 is an example screen display associated with a user interface that may be used to select a geographic location for a map insert or to select location-specific indicia on the map insert to be customized by the user designing the customized greeting card;

FIG. 11 is an exemplary display screen associated with a user interface that may be used to select a printing, delivery, or electronic display option;

FIG. 12 illustrates an exemplary customized greeting card constructed using the system of the present disclosure and including customized indicia;

FIG. 13 illustrates the customized greeting card of FIG. 12 and shows the greeting card opened to reveal a map insert, location-specific indicia, and customized indicia;

FIG. 14 illustrates another exemplary customized greeting card and including customized indicia;

FIG. 15 illustrates the customized greeting card of FIG. 14 partially opened;

FIG. 16 illustrates the customized greeting card of FIGS. 14 and 15 in a fully-opened position to reveal a map insert, location-specific indicia, and customized indicia;

FIG. 17 illustrates still another exemplary customized greeting card including customized indicia;

FIG. 18 illustrates the customized greeting card of FIG. 17 partially opened;

FIG. 19 illustrates the customized greeting card of FIGS. 17 and 18 in a fully-opened position to reveal a map insert, location-specific indicia, and customized indicia.

### DETAILED DESCRIPTION

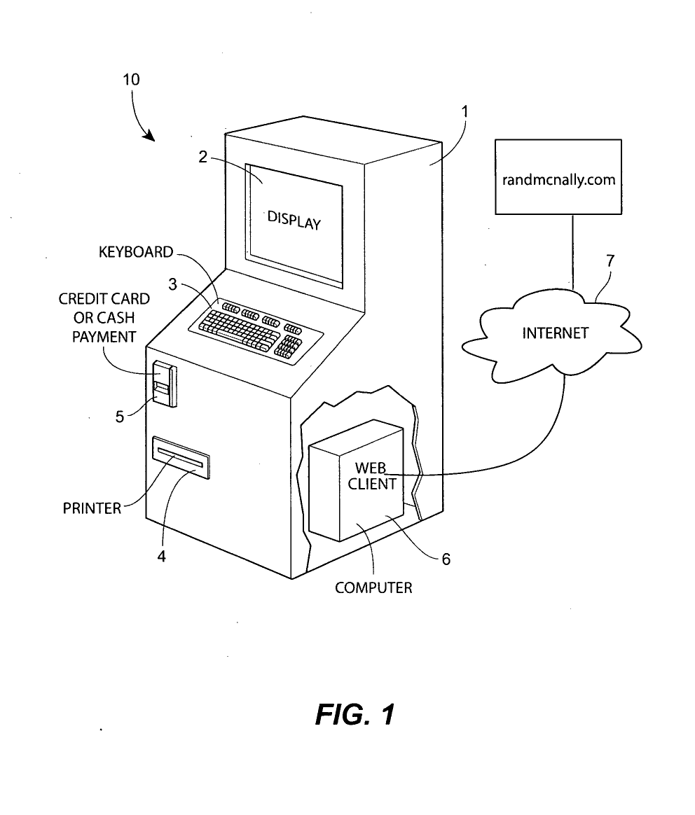

FIG. 1 illustrates components of an electronic custom greeting card design and presentation system 10 assembled in accordance with the teachings of the present invention, and including a kiosk 1 having a display 2, a keyboard 3, a printer 4, a payment slot 5 (to accept cash, credit cards, stored value cards, etc.), and a computer 6 operatively coupled the internet 7. The computer may include, a greeting card database, and various user interface routines, all of which will be explained in greater detail below.

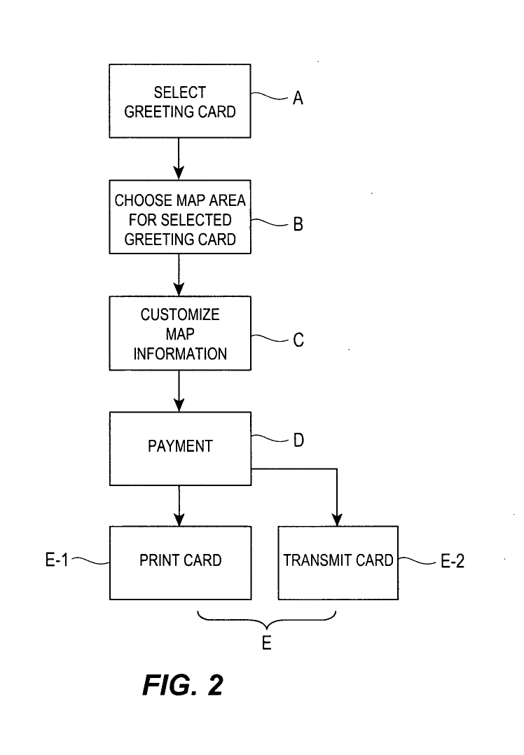

FIG. 2 illustrates an exemplary method of creating and printing and/or sending a customized greeting card. A user (not shown) may use the kiosk I of FIG. 1, or any other suitable user interface discussed below, to select a greeting card at step A. At step B, the user selects a map area for insertion into the selected greeting card, and at step C the user may elect to customize map information on the map insert. Step D enables the user to elect and carry-out a form of payment, and the at step E the system presents the user with a number of sending options, including printing the card at step E-1 or transmitting the card electronically at step E-2. The components shown in FIGS. 1 and 2, and the resulting actual or electronic greeting card, will now be discussed in additional detail with respect to the remaining Figures.

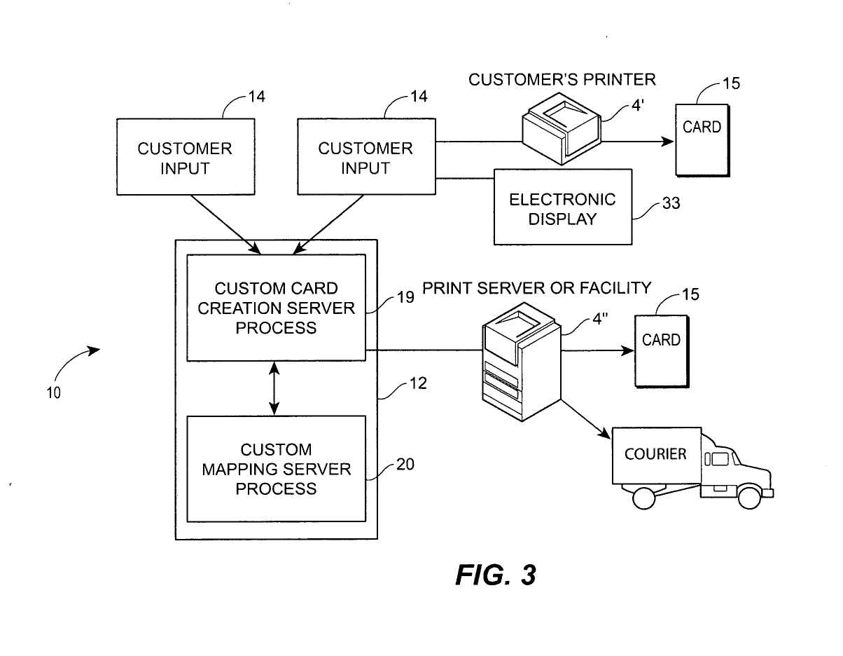

FIG. 3 illustrates additional details of the electronic custom greeting card design and presentation system 10. The electronic custom greeting card design and presentation system 10 includes an image server 12 connected to various web clients 14 (e.g., customers) via one or more communication connections which might be, for example, the Internet, the world wide web, a dial up connection or any other suitable public communication network. Generally speaking, the greeting card creator or user, accessing an electronic display 33, will use one of the web clients 14 to interface with the image server 12 to design and print a custom greeting card 15 using, for example, a home printer 4′ or an attached printer 4″ (which may be part of the kiosk 1 of FIG. 1). As a result, the image server 12 interfaces with each of the web clients 14 and sends information to each of the web clients 14 for generating particular greeting cards being designed by the user(s) at the web clients 14. The image server 12 includes a custom card creator server process 19 and a custom mapping server process 20.

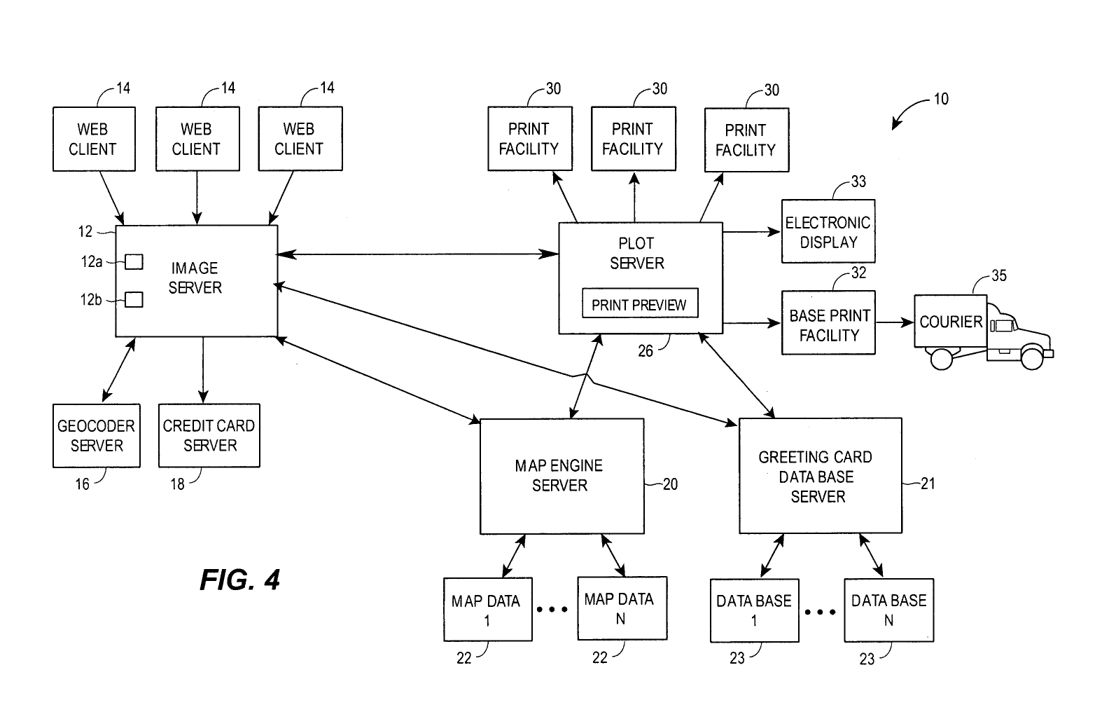

As illustrated in FIG. 4, the image server 12 is communicatively connected to a number of other components including a geocoder server 16, a credit card server 18 (which may be any typical server or computer system used to implement a standard electronic shopping cart or purchasing system), a map engine server 20, and a greeting card database server 21. The greeting card database server 21 is connected to one or more greeting card databases 23 which are copied into the greeting card database server 21 and store greeting card data used to generate or create greeting cards. Similarly, the map database server 20 is connected to one or more map databases 22 which are copied into the map database server 20 and store map data used to generate or create maps such as wall maps, street maps, folding maps, atlases, etc.

The greeting card databases 23 may store greeting card data in any desired format or using any desired storage and retrieval methodology such as those typically used by electronic greeting card providers. Also, the greeting card data may be stored in a single database 23 (or computer memory) or may be stored in multiple different databases located at the same physical place or located at different physical places, such as in different cities, in different states, etc. The map data may be stored in a single database 22 (or computer memory) or may be stored in multiple different databases located at the same physical place or located at different physical places, such as in different cities, states, etc., and the map databases 22 may store map data in any desired format or using any desired storage and retrieval methodology such as those typically used by map providers. In one embodiment, the greeting card data within the databases 23 may be stored based on holidays, events, or other occurrences, such that a first one of the greeting card databases 23 stores greeting card data pertaining to, for example, the New Year's holiday, while another greeting card database 23 stores greeting card data pertaining to birthdays.

As also illustrated in FIG. 4, a plot server 26 is communicatively connected to the map engine server 20 and to the greeting card database server 21, and to the image server 12. Further, while not shown as such, the plot server 26 may also be communicatively coupled to one or more of the geocoder server 16 and the credit card server 18. The plot server 26 obtains a map file and a greeting card file, or a single job file containing both a map file and a greeting card file, from or via the image server 12. The map file and the greeting card file, or a combination map and greeting card file, define the parameters of both a map and a greeting card designed by a user at one of the web clients 14. When the user designs a greeting card with a map insert, greeting card data is obtained from the greeting card database server, while map data is obtained form the map engine server 20. The plot server 26 then uses the map data and the greeting card data to create a print file (which could be simply a display file as will be explained in detail below) and communicates with one or more print facilities 30 or 32 to have the print file printed into a greeting card and possibly delivered to a user via a courier service 35.

Generally speaking, when the user desires to create a customized greeting card, the user will access (or log into) the image server 12 via one of the web clients 14 using any standard internet communication connection. The image server 12 may run a greeting card design program (not shown) stored in the memory 12b using the communications from the web client 14 as inputs, to enable the user to design a particular greeting card. Similarly, the image server 12 (which includes a processor 12a and a memory 12b) may run a map design program (not shown) stored in the memory 12b using the communications from the web client 14 as inputs, to enable the user to design a particular map or map insert. As part of this process, the image server 12 (and more particularly, the greeting card design program and the map design program) will accept inputs from the user as to the type and nature of the greeting card to be created along with input from the user as to the type and nature of the map or map insert desired, and will interface with the geocoder server 16, the credit card server 18, the map engine server 20, and the greeting card database server 21 to obtain various types of information or data needed to create and view the greeting card and/or the map or map insert being designed and will provide an illustration to the user (via the web client 14) of the greeting card and/or the map insert being designed. The greeting card design program and the map design program may allow the user to change the design criteria for the greeting card and/or the map insert to thereby customize the card or the map insert to best suit the user's needs. Once the card and map insert are designed (or during the design process), the map design program may create one or more map files including the data necessary to specify or define the map being designed, such as the size, coverage area, zoom level, etc. of the map insert, and the greeting card design program may create one or more greeting card files including the data necessary to specify or define the greeting card being designed, such as the size, layout, type of message, etc. of the greeting card. This print file does not need to include all of the map data and/or greeting card data that will be used to actually print and/or display the designed greeting card, as this data may be accessed during a later printing step directly from the appropriate map database 22 on the map engine server 20 and/or from the greeting card database 23 on the greeting card database server 21.

As will be understood, the image server 12 may provide any desired set of user interface displays to the web client 14 to enable the user at the web client 14 to customize the design of the greeting card including, for example, interfaces that allow the user to select the size of the card, the type of card, the size and scale of the map insert along with the area to be covered by the map insert, the level of detail to be shown in the map, customized information to be put in the map such as particular locations associated with the user (e:g., star icons at residential or business addresses associated with the user), map titles, radius circles centered around a particular address or point on the map, etc. As discussed in more detail below, the map and greeting card design programs allow the user to view the greeting card (on the interface or computer screen at the web client) in one or more levels of detail. In particular, the greeting card and the map insert may be generally displayed or represented on the user interface at the web client 14 using a first level of detail which does not include all of the detail that will be present on the final greeting card. This first level of detail or resolution makes it easier for the user to view the greeting card and/or the map insert on the user interface for the purpose of designing the general characteristics of the greeting card and/or the general characteristics of the map insert. For example, the user may select the appropriate size for the card and for the map insert, the coverage area of the map insert as well as the location of the map insert in the greeting card, a title for the card and/or for the map insert, etc. This first level of detail or resolution eliminates less important map or greeting card information displayed on the user interface, such that the presented information is more understandable and readable to the user. However, the map design program and/or the greeting card design program may allow the user to view portions of the map and/or portions of the greeting card (via the user interface at the web client 14) in the level of detail or resolution that will actually be present on the physical greeting card as printed on a substrate or on the electronic greeting card as displayed on an appropriate display.

In any event, when a user is satisfied with a particular greeting card design, including the map selection, the image server 12 will send the print file (specifying the map design parameters such as the map size, coverage area, level of detail, customized features, etc., and specifying the greeting card design parameters such as the type and content of the message, the size of the card, etc.) to the plot server 26. The plot server 26 uses the print file to access the map engine server 20 and the greeting card database server 21 which will, in turn, access the appropriate map databases 22 and the appropriate greeting card databases 23 to obtain the map and greeting card image information to be printed on the greeting card (or to be displayed on an appropriate display) according to the design criteria. The plot server 26 then sends the print file to one or possibly more of the print facilities 30 or 32, with the print facility specified by the user at the web client 14. The selected print facility may be a print location within the coverage area of the map insert, a print location close to an address specified by the user, a local printer accessible by the user, or any other print location determined to have the appropriate printing equipment to print the greeting card, etc. On the other hand, the user may specify that the greeting card be delivered to the user or to a selected recipient, in which case, the plot server 26 may send the print file to a base printing facility 32 associated with, for example, a greeting card provider. The base printing facility 32 may then print the greeting card as specified by the print file and send the greeting card to the user using any desired delivery mechanism, such as the courier 35 (illustrated in FIG. 4), which may be the postal service, etc. Finally, the user may elect to bypass the printing step entirely, and instead have the print file routed (using appropriate electronic or wireless routing technology such as via the internet, via telephone lines, wirelessly, etc.) to an appropriate electronic display 33 shown in FIG. 3. The electronic display may be any suitable electronic interface such as, for example, a personal computer (PC), a personal digital assistant (PDA), a cell phone, or any other device capable of displaying the print file to either the user or the recipient. Of course, the system illustrated in FIGS. 1 through 4 and described further herein may be scalable. Thus, additional or fewer image servers 12, map engine servers 20, greeting card database servers 21, and plot servers 26 can be added or used as needed.

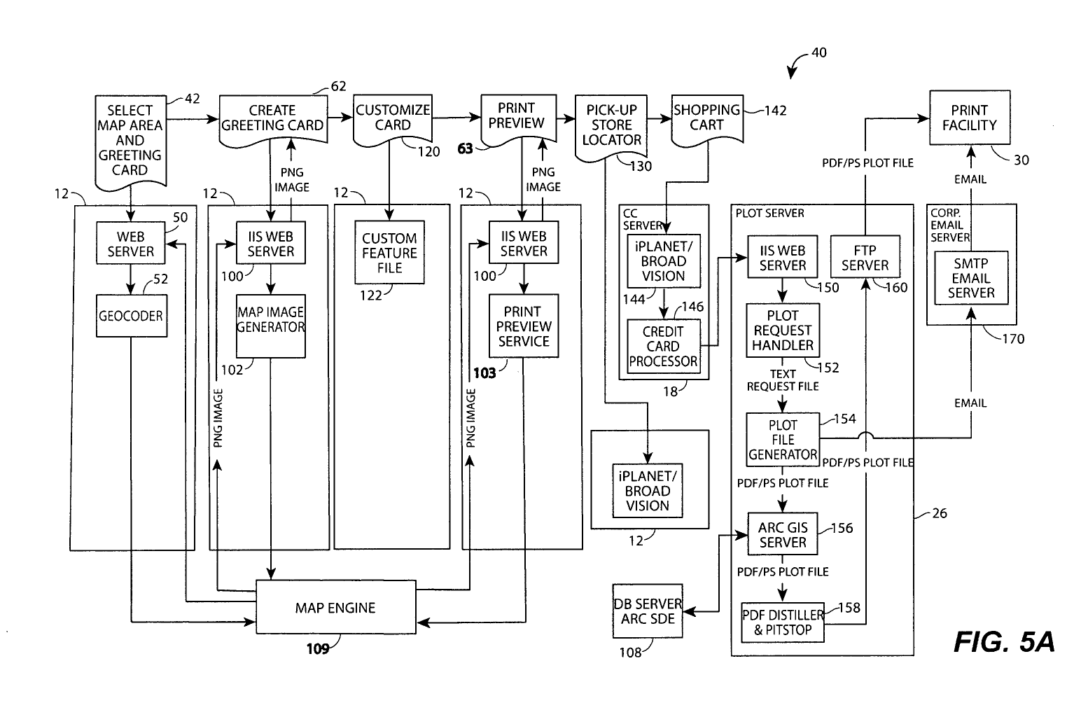

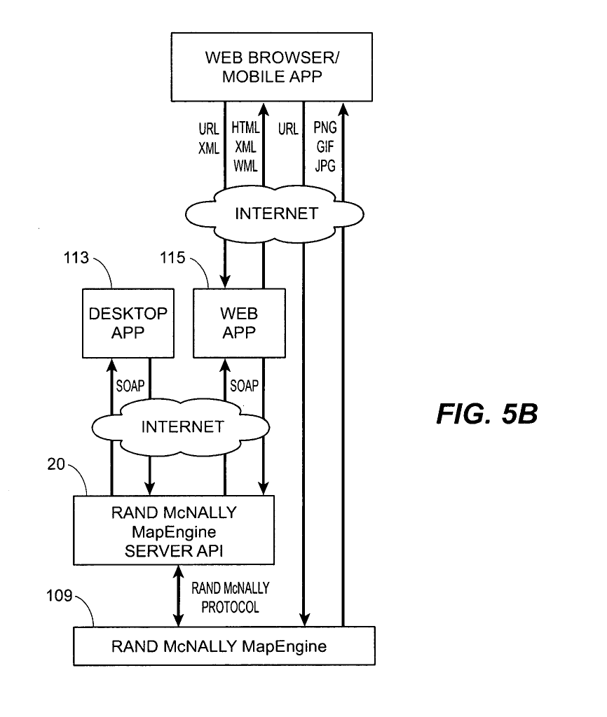

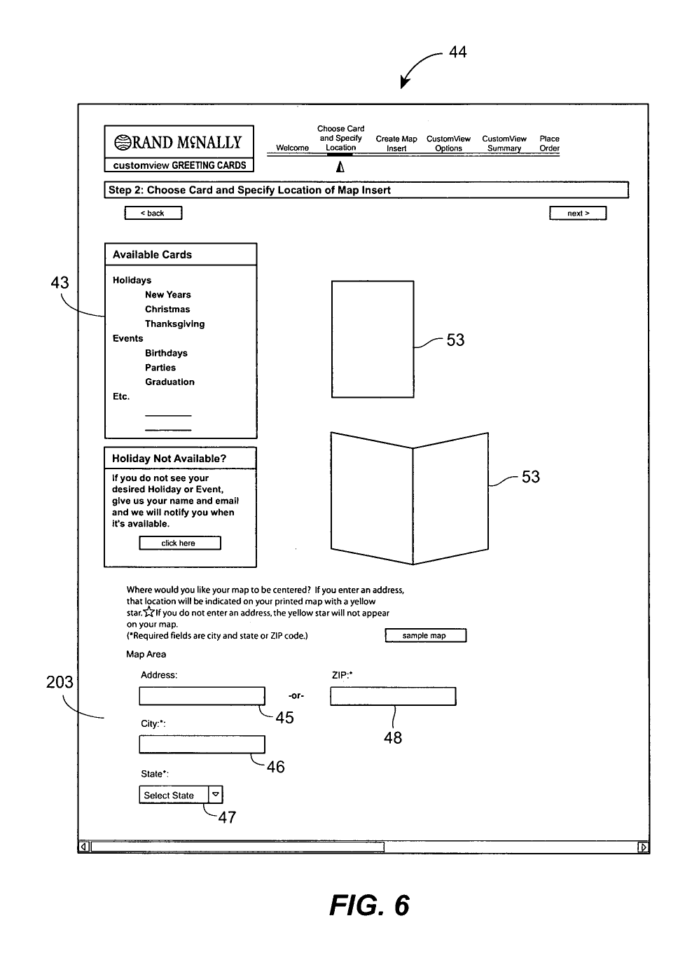

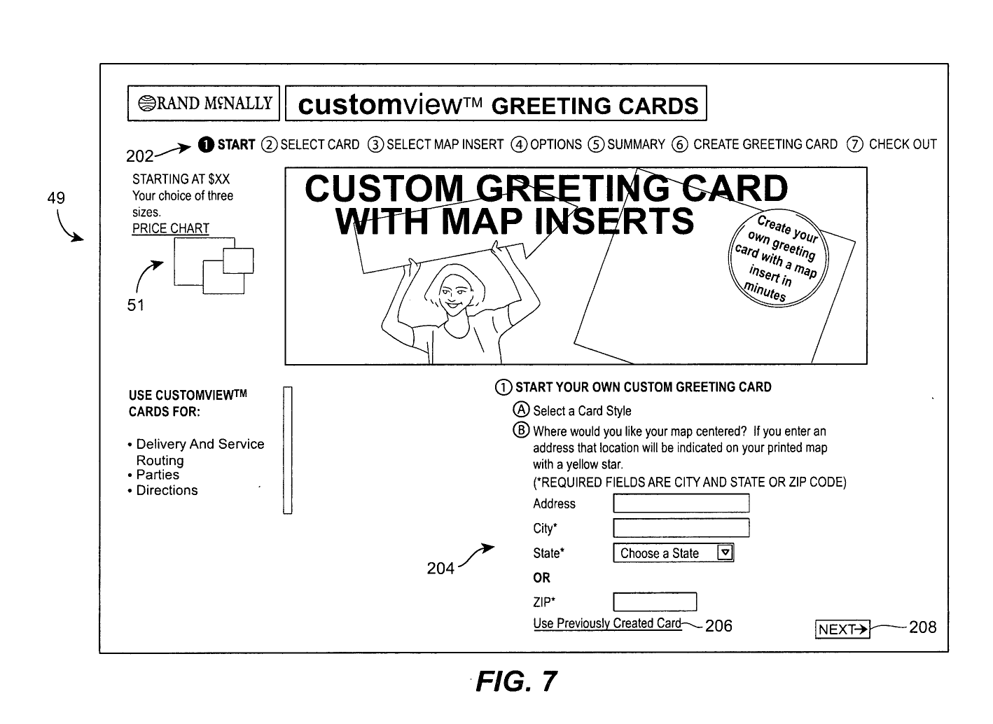

FIG. 5A illustrates a manner in which the different steps of the greeting card design and printing procedure are implemented using the system 10 of FIGS. 1-4. In particular, at block 42, the user (at one of the web clients 14 of FIG. 4) logs into the appropriate website hosted by, for example, the image server 12, and selects both the desired greeting card and the desired map location. FIG. 6 illustrates an exemplary screen display 44 which may be presented to the user at the web client 14 to allow the user to select a greeting card and to specify a general map area for the map insert. The screen display 44 of FIG. 6 may be preceded by a welcome screen display 49 as shown in FIG. 7. In the screen display 44 of FIG. 6, the user may select a greeting card and specify a message for the greeting card. As illustrated in FIG. 6, the user may enter the desired greeting card using a box 43, which may present a variety of options from, for example, a pull down menu.

As is also illustrated in FIG. 6, the user may enter, via appropriate boxes 45-48 a street address, a city and a state (which may be selected by entering or by selecting from a pull down menu) or may enter a zip code. Of course, if desired, the user may enter any other indication of an address, a region or a geographical location of any kind (such as a city) to specify a starting point for the map insert, e.g., a location to be contained within the insert. As illustrated in FIG. 6, the user may select an appropriate format or price of greeting card from, for example, a list of available options, via appropriate boxes 51 (FIG. 7) or 53 (FIG. 6), with the options presented graphically or via a pull down menu.

Referring back to FIG. 5A, the location specified by the user at the block 42 is provided to the image server 12 which, using the map design program, determines whether map data is stored for the region or area with which the specified location is associated. In particular, a web server 50 (which may use any standard server program and hardware) associated with the image server 12 communicates with the geocoder server 16 and provides the specified address or location to the geocoder server. As generically illustrated by the block 52, the geocoder server 16 uses any standard or known geocoding technique to convert the address or other location information into a predetermined coordinate system that can be used to locate specific map data within the map databases 22.

The geocoder information is provided to a map engine 109 (FIG. 5B). The map engine 109 includes the map engine server 20. The map engine server 20, in turn, receives and transmits data from users via desktop applications 113 and/or web applications 115 through the internet. The map engine server 20 is a subscription web based service that holds the map database 22 (FIG. 4). The map engine server 20 provides software methods and properties to allow a user to query the map database 22 for map images, geocodes, routing directions and spatial searches. A user supplies the map engine server 20 with a desired address through the desktop application or the web application. The map engine server 20 returns a latitude/longitude that can be used in a subsequent map image request. In the subsequent request, the user supplies a map scale and a map pixel size (based on entered preferences described below) and the map engine server 20 creates a digital map image containing the desired map data.

The map engine 109 determines the market and/or area associated the latitude and longitude determined by the geocoder 52 and, in effect, determines which map database 22, if any, contains the map data associated with specified location. The map engine 109 interprets the geocoded information, and determines whether actual map data exists in the appropriate map database 22 (FIG. 4) for the located geocoded information within the located market and area.

The greeting card specified by the user at the block 42 also is provided to the image server 12 which, using the greeting card design program, determines whether greeting card data is stored for the selected greeting card. In particular, the web server 50 (which may use any standard server program and hardware) associated with the image server 12, or a dedicated greeting card web server separate from the web server 50, communicates with the greeting card database server 21 (of FIG. 4) and provides the specified information thereto.

The greeting card information is provided to a greeting card lookup routine or system which may be stored in any desired server associated with any generalized database. The greeting card lookup routine determines the type of card chosen by the user and, in effect, determines which greeting card database 23, if any, contains the card data associated with specified greeting card. This look up step is used to determine whether greeting card data actually exists for the specified greeting card.

As will be understood, the screen display 33 of FIG. 4 may be used to specify a starting center location of the map insert. However, during the design process, the user may change the center location of the map insert. Furthermore, while the user interface of FIG. 4 allows a user to enter a particular address, a particular address may not be needed and, instead, the blocks 50, 52, and 109 may operate based on the name or location of a city, a town, a region, etc. to determine if sufficient map data exists for that location. If desired, the map insert design program may place a star or other icon on the map insert being created at the address, city, etc. specified by the user when a user specifies a valid address or location.

In any event, at the create greeting card step 62 of FIG. 5A the map design program uses the center coordinates specified by the user to select a first set of parameters defining a map, and uses the greeting card design program to select a set of parameters defining a greeting card. The map parameters may include the center point (entered by the user via the interface of FIG. 4), the size of the map insert (i.e., the physical size of the map insert to be printed, or the size relative to the overall size of the selected greeting card), the coverage area of the map (i.e., the boundaries of the map data to be printed on the greeting card), the orientation of the map insert and/or the greeting card, the zoom level of the map insert, etc. Such parameters may be selected based on preset or default parameter settings stored within the image server 12 or at the web client 14 or may be initially specified by the user. In any event, the map design program uses the initial center location as specified by the user and the default or initial parameter settings to create a first map file, and uses the greeting card information specified by the user in FIGS. 6-8 to create a first greeting card file, which may be separate or the same as the map file. A low resolution depiction of the map insert along with a depiction of the greeting card are then presented to the user via the user interface at the web client 14. Upon viewing the low resolution depiction of the greeting card and map insert, the user may make changes to the greeting card or to the map insert, or both. For example, the user may alter the map to cover a different location, to cover more or less of a geographical region, to include more or less map detail information, to move the center point of the map insert, to change the physical size or orientation of the map insert as printed on the card, etc. The user may also make changes to the greeting card information.

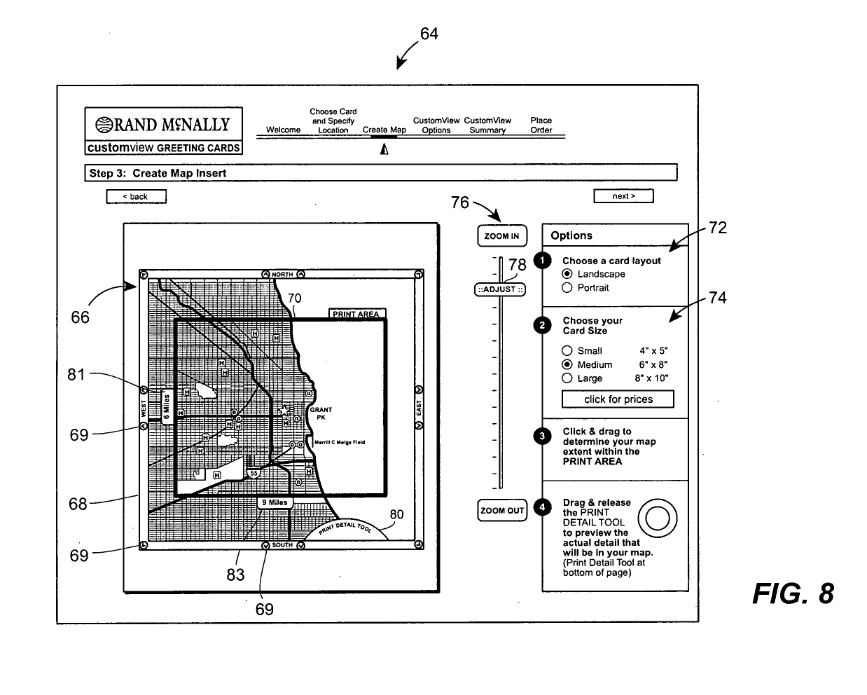

FIG. 8 illustrates an example entry screen display 64 which allows a user to view a depiction of a map insert being created and to select or specify map parameters associated with the map insert being created. As illustrated in FIG. 8, the screen display 64 includes a map area 66, in this case illustrating Chicago, Ill., bounded by an outer box 68 having arrows 69 thereon pointing to directions such as north, south, east, west, northeast, northwest, southwest and southeast. Alternatively, the map area 66 may be bounded by the size of the chosen greeting card. Furthermore, an inner box 70 illustrates the actual area to be covered by the map insert as currently designed (or as currently specified in the map file). Control and selection boxes on the right side of the display 64, which may be used in any order, enable the user to customize the design of the map insert, and customize or change aspects of the greeting card. For example, the user may use a card layout box 72 to choose the orientation of the greeting card to be either landscape or portrait, and may use a sizing box 74 to select the actual printed size of the greeting card being designed. Additionally, the user may use a slider control 76 with a slider button 78 to adjust the magnification (also called zoom or scale) of the map insert or the greeting card. By adjusting the slider button 78 up or down, the zoom of the inner box 70 may be changed to cover more or less geographical area. In one embodiment, the slider control 76 will alter the level of map detail to actually be printed on the greeting card in a manner described in more detail below.

The user may also pan the area to be viewed or covered by the map boundary 70 by pressing the buttons 69 on the outer box 68, which moves the entire map area 70 in a specified direction such as north, south, east or west or a combination of these such as, north and west or north and east, etc. In addition, the user may move the map beneath the inner box 70 to change the area within the map boundary 70 by clicking and dragging any section of the map viewable within the outer box 68 until the desired portion of the map is contained within the boundaries of the inner box 70. As illustrated in FIG. 8, the inner box 70 specifies the print area of the map insert and includes indications of the vertical scale 81 and the horizontal scale 83 of the map insert. Thus, the map insert defined the by the box 70 of FIG. 8 is configured to cover a six mile by nine mile rectangle. Of course, adjusting the slider 76 changes the scale covered by the map (e.g., if the slider button 78 is moved towards the zoom out position, the map scales 81 and/or 83 will increase).

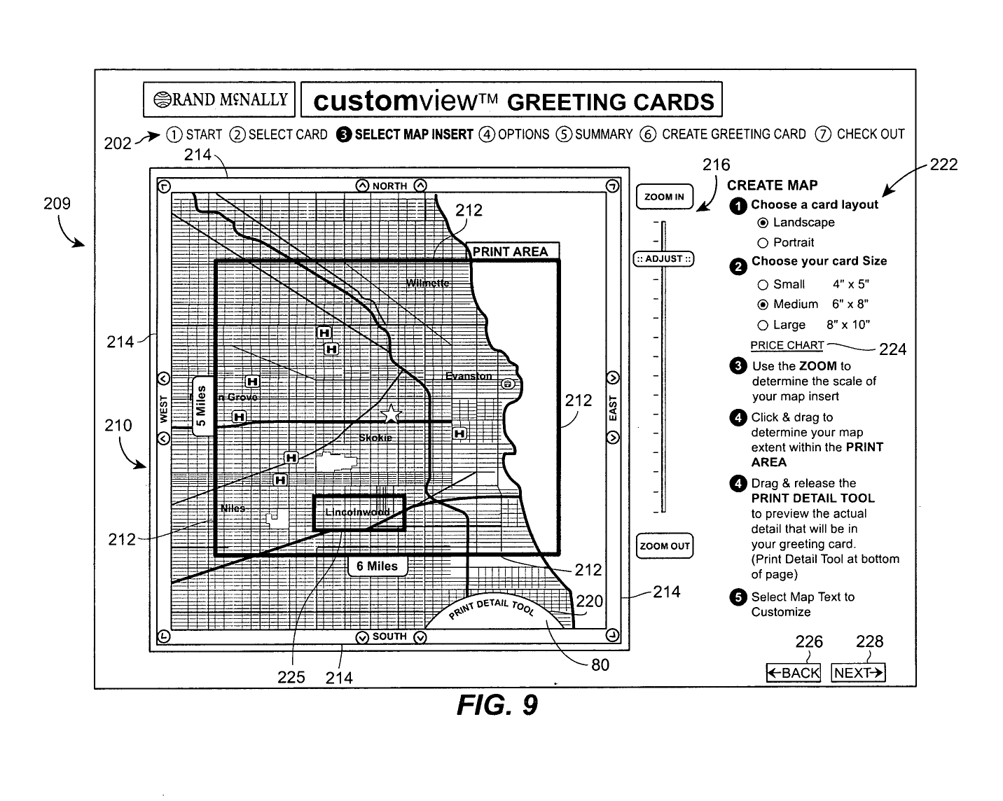

As shown in FIG. 9, a print detail tool 80 may be provided. The user may use the print detail tool 80 to display the actual map details which will appear on the printed map insert on the selected greeting card. The print detail tool 80 may be dragged by the user to a portion of the map insert as displayed within the box 68 or within the inner box 70, and enables the user to view the actual level of detail to be printed on the printed greeting card. The print detail tool 80 may allow the user to target a specific area and, once the user has positioned the print detail tool 80 over the specific area, the print detail tool 80 activates and expands the selected portion of the map insert. Of course, each time the user uses the print detail tool 80, the needed map details are obtained from the map database 22 and/or from the greeting card database 23 as required and display as needed on the user interface.

Referring again to FIG. 5A, during the greeting card creation step 62, the user uses the web client 14 to communicate with the image server 12 to obtain image data for display to the user, as well as to inform the map design program and the greeting card design program running within the image server 12 of changes to the parameters of either the map insert or the selected greeting card. In particular, each time a user uses the screen displays of FIGS. 6 through 11 to change the design of the map insert or any details of the greeting card, the web client 14 communicates with the server 12. As illustrated in FIG. 5A, an IIS web server 100 within the server 12 receives new map insert and greeting card design parameters based on user operations at the appropriate screen display. The wall map design program running on the server 12 creates a new map file and the greeting card design program creates a new greeting card file, and operates to generate a new image for display to the user interface at the web client 14. As part of this image generation procedure, the web server 100 provides the new map or greeting card design parameters to a greeting card image generator 102 which operates to generate a wrapper file specifying the details of the greeting card and the map insert needed to create a display within the user interface based on the user's operations. The image generator 102 sends the wrapper file to the map engine 109.

As will be understood, and as discussed with respect to FIG. 4, the map engine server 20 and the greeting card database server 21 obtain the requested information from the appropriate database 22 and/or 23 residing on the appropriate database server 20 or 21, and send the data to the image server 12, which renders the geographic and greeting card data into a greeting card image in a PNG format.

In any event, using the screen displays of FIGS. 6-11, the user interacts with the image server 12 to design and view a greeting card. When the user is satisfied with the size, layout, and/or content of the card and the size, layout, coverage, level of detail, etc. of the map insert, the user may, at a block 120 of FIG. 5A, customize the greeting card by specifying other features to be printed on the greeting card. These additional features need not be stored or obtained from the data stored in the appropriate databases 22 or 23. Instead, such additional features may be customized by the user. Such custom features may include, for example, indications of icons to be located at specific addresses at which, for example, the user may have preferred customers, may have business locations etc., titles to be printed on the map insert, radius circles indicating mileage from a specific point or specific points on the wall maps, logos or messages, such as “You Are Here” messages, etc. Any desired user interface or screen display could be used to enable the user to specify the custom features to be printed on the greeting card designed at the block 62 and to then view the specified custom features using the print detail tool 80. As illustrated in FIG. 5A, a custom feature file program 122 may be used to create a custom feature file specifying the custom features added by the user via the user interface at the web client 14. Of course, such custom features may include any of the features discussed above or any other desired features to be added to the greeting card when printed.

A user may preview the image at the print preview box 63. Print preview 63 receives a PNG image from the IIS web server 100. A print preview service 103 sends card and map data to the map engine 109, which generates the PNG image and sends the PNG image to the IIS web server 100.

As indicated by the block 130 of FIG. 5A, after customizing the greeting card, the user may then select or choose a location at which the greeting card is to be printed and a manner in which the printed greeting card is to be delivered to the user, or may select how the greeting card may be displayed to the user. In particular, the user may specify whether the greeting card as designed in the blocks 42, 62 and 120 is to be printed and delivered to the user via a courier or other delivery service, or whether the greeting card is to be printed at a local third party print facility or other copying/printing provider and to be picked up by the user. Alternatively, the print facility may mail or otherwise physically deliver the greeting card to the user or to a designated recipient. Finally, the greeting card may be delivered electronically to a PDA, cell phone, or other user interface, as discussed above.

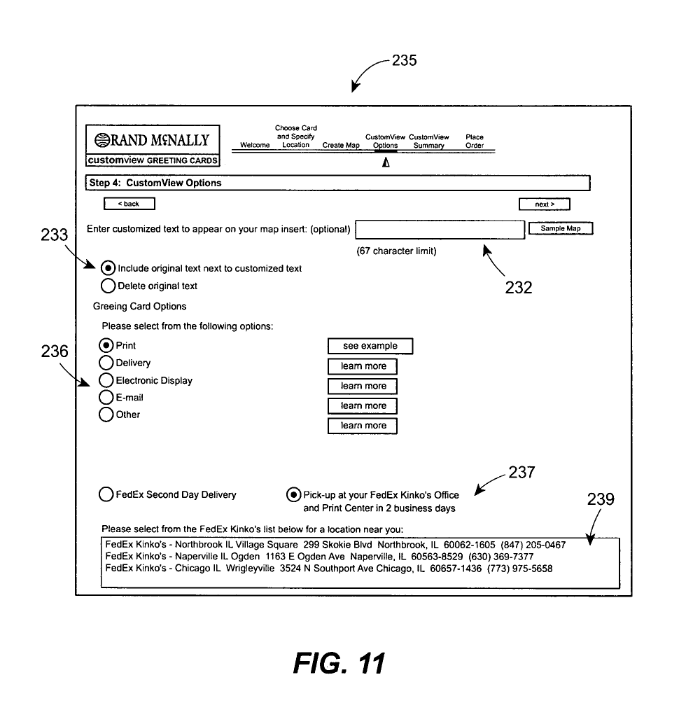

Referring to FIG. 11, the screen display 235 includes a number of user options. At 233, for example, the user may select to include original text from the map insert in conjunction with any map text that has been customized by the user. At 236, the user may select a variety of delivery options including print (which may be at a user-designated printer), delivery, electronic display, e-mail, or other possible options. At 237, the user may use check boxes designated by the to specify whether the greeting card is to be delivered via a courier printed out at a specified print facility and picked up by the user; printed at a local printer, or transmitted to a recipient for electronic display. If the user selects to have the greeting card printed at, for example, a local print facility, possible choices may be displayed in the box 239, and the user may highlight or click on one of the facilities listed in the box 239 to select that print facility. The display box 239 may be used to display all of the printing facilities that are available to print the greeting card, or the display box 239 may display a subset of the possible print facilities, such as the print facilities within the area encompassed by the map insert being printed on the greeting card, or within a specified distance from the user's location or other specified address. Of course, information about the possible print facilities may be stored in a file on, for example, the image server 12 and this file may be accessed to determine the printing facilities at which the wall map may be printed (i.e., to be listed in the box 239 of FIG. 11). If desired, the print facilities listed in the box 239 may be chosen based on the location of the print facility or the printing capabilities of a given facility, or both. As illustrated in FIG. 4, the image server 12 may use an iplanet/broadvision component stored on the credit card server 18, which is a known server program, to store all of the potential printing facilities and to determine whether particular printing facilities are in the correct geographical area and/or have the proper printing equipment to print the wall map specified by the user.

Of course, in the case in which the user opts to deliver the greeting card directly to the user or to a designated recipient via, for example, a courier service, the greeting card design program may automatically specify that the card is to be printed at a default printing facility, such as one associated with the greeting card provider (illustrated in FIG. 4 as the base print facility 32). In this case, the base print facility 32 may be used to print the greeting card and a courier service 35 may deliver the card directly to the user or to a designated recipient.

Referring again to FIG. 5A, After the user specifies a print facility and delivery method at the block 130, the user may be transferred to a typical or standard shopping cart system which allows the user to purchase the greeting card designed at the blocks 42, 62, 120, and 130. Such a shopping cart procedure, which is illustrated by the block 142, may use an iplanet/broadvision component 144 and any credit card processing software 146 located in the credit card server 18 of FIG. 4 to perform standard charging and order completion procedures for the greeting card.

After the user has actually purchased the greeting card using the shopping cart procedure at the block 142, the credit card server 18, which may be encompassed within or which may communicate through the image server 12, notifies the plot server 26 of FIG. 4 that a proper order has been placed and that printing is needed. At this time, the user may also be prompted to see if the user wishes to bypass the printing process and instead seek to send the card electronically for display on an appropriate user interface as referred to above. In any event, the image server 12 using a communication connection illustrated by a line between the image server 12 and the plot server 26 of FIG. 4, sends the map insert and greeting card files (including any customized features file) to the plot server 26 to be used by the plot server 26 to create a print file having all of the image data to be printed on the greeting card. As indicated above, the file generated within the image server 12 contains a specification of the map insert as well as files or data specifying basic and customized information to be printed on the greeting card.

As illustrated in FIG. 5A, the plot server 26 receives the print file via an IIS web server 150. While the server 150 is illustrated as being connected directly to the credit card server 18, which in this case is handling the shopping cart program, the IIS web server 150 may receive the card file directly or indirectly from the image server 12. The IIS web server 150 associated with the plot server 26 hands off the request (and the associated print file) to a plot request handler 152, which parses the print file and sends a text request file to a plot file generator 154 requesting that a plot or print file be created for the card based on the information within the print file. The plot file generator 154 creates a base PDF/PS plot file and specifies the nature of and the extent of the card to be created (as determined from the parameters specified in the print file) and accesses the actual data (map data and greeting card data) to be used to generate the map via an ARC GIS server 156 associated with the plot server 26. The ARC GIS server 156 communicates with the ARC SDE sever 108 within the appropriate map and card database servers 20 and 21 to obtain the appropriate data from the appropriate databases 22 and 23.

In any event, the ARC GIS server 156 provides a complete PDF/PS plot file having all of the needed data for the designed greeting card. As will be understood, the plot file generator 154 operates in conjunction with the ARC GIS server 156 to merge the card detail data delivered from the map engine server 20 and the greeting card database server 21 (FIG. 4) with the customized information specified by the user at the step 120 (FIG. 5A) to create a single PDF/PS plot file defining the greeting card.

As illustrated in FIG. 5A, the PDF/PS plot file is delivered to a PDF distiller program 158 which processes the PDF/PS plot file image to create a high quality viewable greeting card image in the form of a PDF/PS print file based on the printing equipment to be used to print the greeting card as well as other information about the greeting card. As part of this process, the PDF distiller program 158 may use the PitStop software, which is a commercially available software program, to create or process the PDF/PS plot file image using any standard or known pre-press techniques (e.g. overprinting, transparency or spot color). The PDF print file is then provided to an FTP server 160 which sends the processed PDF print file to a print facility 30 or which makes the processed PDF print file available for download to a print facility 30. The print facility 30, using Adobe Acrobat® software which is a commercially available software program, may facilitate printing greeting cards on different printers with different (varying) size output and different specifications for print resolution (e.g. dots per inch), media types, color systems, and ink types based on, for example, the region covered by the map, the printer being used to print the map, user specifications, etc.

Again with respect to FIG. 5A, the plot file generator 154 may also create an e-mail to be sent to the print facility 30 which has been selected or specified to print the greeting card. This e-mail, which may include information about the customer, information needed to retrieve the PDF/PS print file from the FTP server 160, billing information, printing requirements, delivery requirements, etc., is then sent to the print production facility 30 via an e-mail server 170. As will be understood, this e-mail notifies the print production facility that the order for the greeting card has been placed and that the PDF/PS print file is available on the FTP server 160 for downloading to the print production facility 30 when the print production facility 30 wants to print the greeting card. Upon receiving the e-mail notification, the print production facility 30 may log onto the FTP server 160 to acquire the PDF/PS print file or the FTP server 160 may spool the PDF/PS print file to the print production facility 30 automatically. In any event, the printing facility uses the PDF/PS print file and, if necessary, information within the e-mail to print the greeting card as designed by the user. After printing has occurred, the user may either pick up the greeting card at the print production facility 30 or the print production facility 30 may ship the greeting card to the user using any desired delivery mechanism.

FIGS. 6-11 illustrate additional details of possible screen images that may be presented to a user during the process of creating and ordering a greeting card. In particular, these screens provide a framework in which the user can easily navigate and keep track of the steps involved in the process of creating, viewing and ordering a customized card. For example, the user may start the process at a screen 49 of FIG. 7 in which the area or box 51 indicates a list all of exemplary available cards, or the available cards may be listed at box 43 in FIG. 6. The area 203 on FIG. 6 presents the address options at 45, 46, 47, and 48 for inputting address information in order to obtain a map for the map insert. The area 53 of FIG. 6 may present a graphical depiction of the selected greeting card, and further may illustrate the greeting card and a closed condition as well as in an open condition. Preferably, the greetings contained both on the face of the greeting card and within the greeting card may be visible to the user.

The user also may start the process at a screen 49 of FIG. 7, in which an area 202 indicates the exemplary general steps associated with the process of creating and ordering a customized greeting card. In this case, the steps are labeled as Start, Select Card, Select Map Insert, Options, Summary, Create Greeting Card, and Check Out. Of course fewer, additional or different steps could be used and indicated in the area 202 if desired. The Start step is highlighted in FIG. 7 in bold or in a different color. The order of the steps may be varied. For example, the user may select the greeting card first, or may select a map insert/location first.

As can be seen in FIG. 7, the user may start the process of creating a customized map by clicking on Select a Card Style, which may open a menu of possible cards, and may enter a starting address in an address field 204 to obtain a map insert. Alternatively, the user may select a link 206 to use a previously created greeting card and/or a previously designed map insert that was stored in the system by the same or a different user. After specifying a specific address, city and state, a zip code, or other location indicator, the user may select a Next button 208 to move to the second step of the process, which then causes the system to provide the next screen display to the user, such as the screen display 209 of FIG. 9.

The screen 209 of FIG. 9 may include the area 202, which now indicates that the user is in the Select Map Insert step. Here, all of an initial greeting card 210 may be displayed, or only a portion of the greeting card may be displayed. In the example of FIG. 9, the map insert is displayed prominently and includes the map insert based on the address or location specified by the user. The balance of the card 210 may be cropped significantly. Once again, the user may change the coverage area by dragging the map and moving it with respect to the map borders 212. The user also may move to a different coverage area by manipulating or selecting one or more viewing borders 214, and may adjust the map detail (of the map insert) and/or the scale using the slider 216. Further, the user may view a different level of map detail using the print detail tool 80. The user may select or change parameters for the map insert or for the card using the selection buttons in an area 222 of the screen 209. If desired, one or more links, such as a link 224, may provide a link to other information, such as pricing information, the user may proceed backward or forward using the buttons 226, 228, respectively.

As is also shown in FIG. 9, the user may drag a detail box 225 over selected text contained in the map insert. In the example shown, the user has highlighted the text “Lincolnwood.” The detail box 225, which appears in FIG. 9 as a rectangular box, may be dragged by the user to highlight a portion of the map as displayed within the box 212, which represents the area to be printed on the printed greeting card. The detail box 225 allows the user to target a specific area (such as map text) within the map insert and, once the user has positioned the detail box 225 over the specified area, the detail box 225 activates and expands. The text or area highlighted within the detail box 225 may be user-customized as explained below. A close button may be provided on the detail box 225 to enable the user to close the box and thereby return to a screen similar to that of the screen 64 illustrated in FIG. 8. Otherwise, the user may move the detail box 225 to different sections within the inner box 212 to select different or additional map details within the map insert, and to customize these different or additional areas. Of course, each time the user uses the detail box 225, the map design program will actually obtain the print details from the map database 22 and/or from the greeting card database 23 as required and display as needed on the user interface.

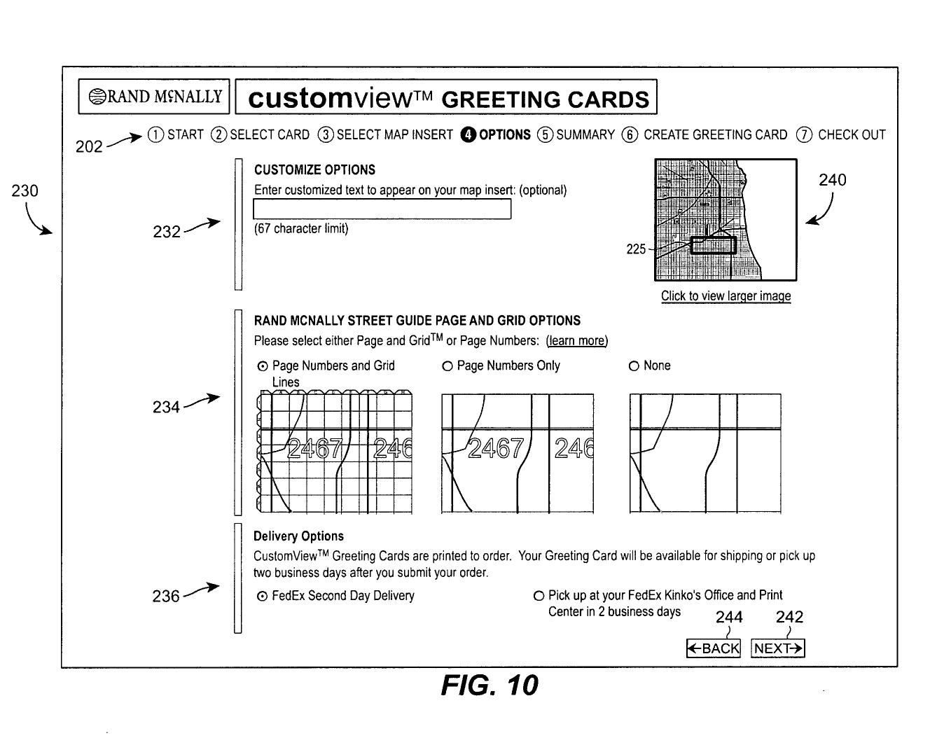

Referring to FIGS. 10 and 11, at area 232 the user has the option of customizing the text selected using the detail box 225 of FIG. 9. The user may elect to customize the selected text so that the customized text inserted at area 232 appears on the map insert in place of the original text highlighted by the user using the detail box 225 of FIG. 9. Alternatively, customized text may appear on the screen or on the greeting card adjacent to the original text.

Still further, a section 236 allows the user to specify delivery options, including for example, second day delivery by a courier, or a pick-up option at a print center. The area 236 may be expanded as shown in FIG. 11 to include additional options, including a print option, a delivery option, an electronic display option, an e-mail option, and other possible delivery and/or display options. Of course, other delivery options may be provided here as well, including regular mail as an example. Still further, other options for the greeting card, such as colors, etc. may be provided to the user or designer in this screen. Also, a generic card preview section 240, in the form of a depiction of a small greeting card, is provided to enable the user to view a preset or generic card to get a general idea of how the printed card may look. In any event, after specifying the options in the screen 230 of FIG. 10, the user may use the Next button 242 to move to the next steps of the process, or may use the Back button 244 to go back in the process to an earlier step.

FIG. 11 illustrates another exemplary display screen 235. The display screen 235 may be used to enable a user to again specify or change the customized text, or specify whether the original text (i.e., before being customized as explained above) will appear on the printed map insert. For example, the original text may appear next to the customized text inserted by the user as explained above. These options may be accomplished by checking boxes at an area 233. The screen 235 also enables a user to select various printing, delivery, and presentation options, such as those options illustrated in area 236. The options may be selected by checking an appropriate box. These options may include, for example, a print option, which may be a local printer or a remote printer, a delivery option, an electronic display option, an e-mail option, or other options. These options or other options may be included on, for example, a pull-down menu.

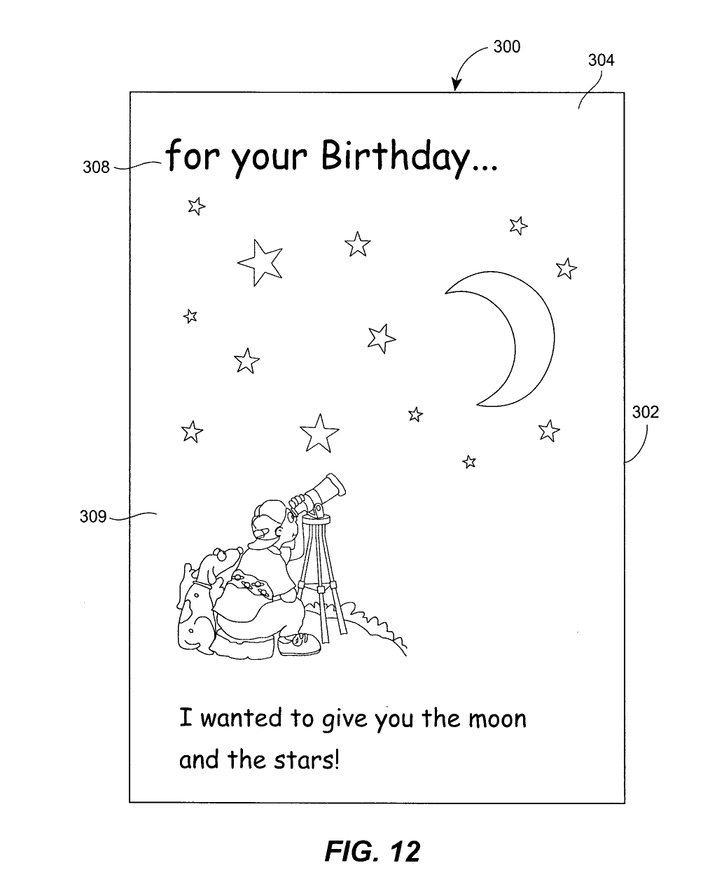

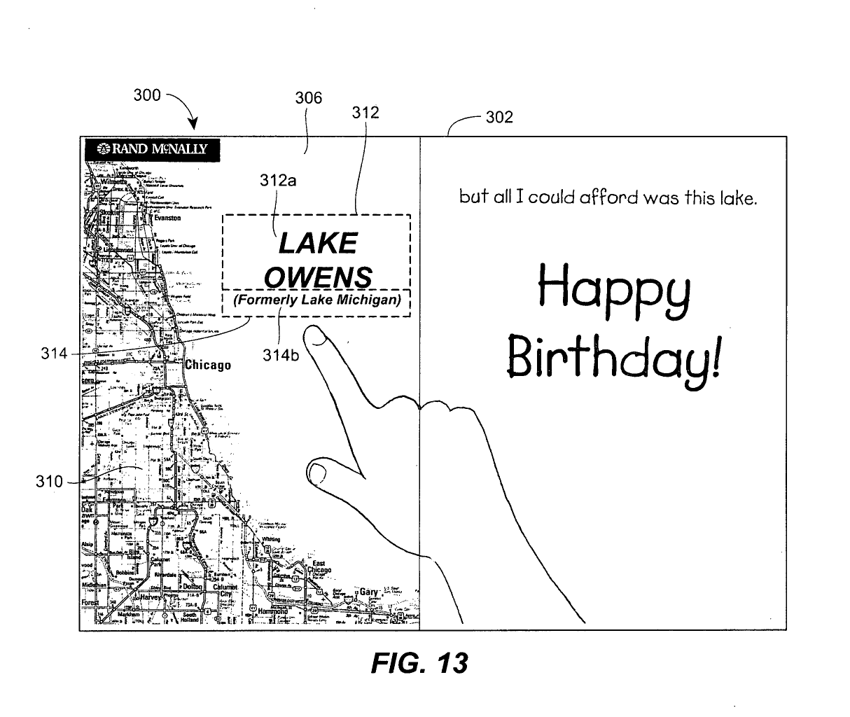

Referring now to FIGS. 12 and 13, an exemplary greeting card 300 is shown. The greeting card 300 is printed on a substrate 302 and includes a number of areas, including an area 304 (shown on a face of the card in FIG. 12), and an area 306 (shown on the interior of the card in FIG. 13). The area 304 includes one or more messages or greetings, such as a message 308 printed on the area 304 as shown in FIG. 12. As shown in FIG. 13, the area 306 includes a map insert 310. It will be understood that additional messages 308 and/or additional map inserts 310 may be provided as desired.

As shown in FIG. 13, the area 306 of the greeting card 300 includes a data field 312 corresponding to the area highlighted in, for example, FIGS. 9 and 10 using the detail box 225. This data field 312 includes customized text 312a inserted by the user as described above. The customized text may be recipient-specific indicia such as, for example, “Lake Owens” instead of the original location-specific map indicia (i.e., “Lake Michigan”). Another data field 314 may be provided. In the disclosed example, the data field 314 is disposed on the substrate 302 immediately adjacent to or below the data field 312. In a sample shown, the data field 314 refers to the original location-specific map indicia 314b that would normally occupy the data field 312. Specifically, the term “formerly Lake Michigan” makes reference to the fact that the term “Lake Owens” now occupies the data field that would, in a conventional map, say “Lake Michigan.” Thus, the information in the data field 312 is specified by the user and, in accordance with the disclosed example, the information in the data field 312 may be specific to a recipient of the card (i.e., the recipient of the card presumably has the surname “Owens”).

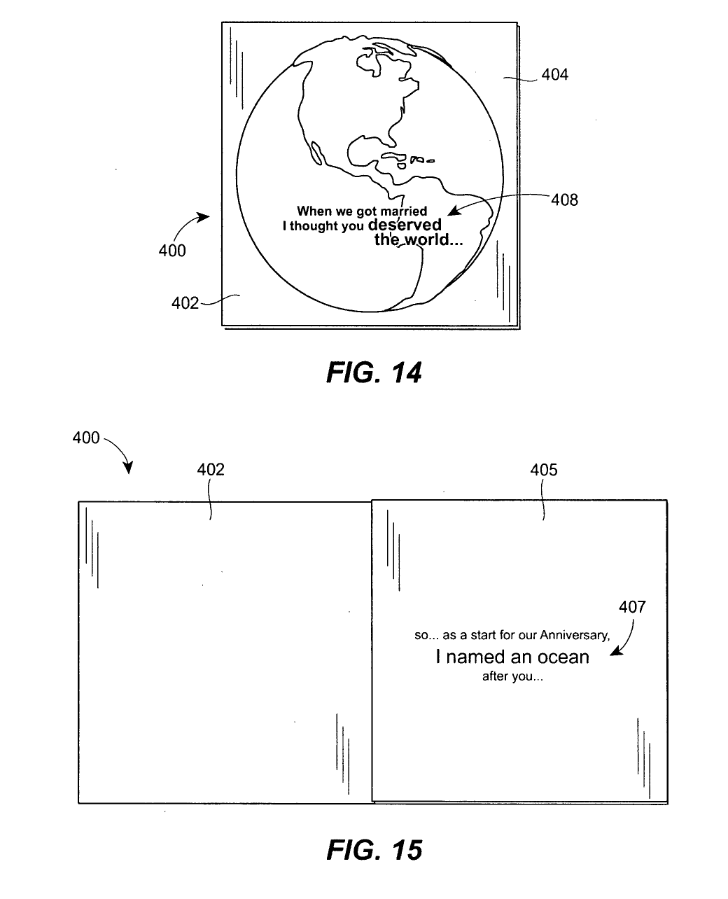

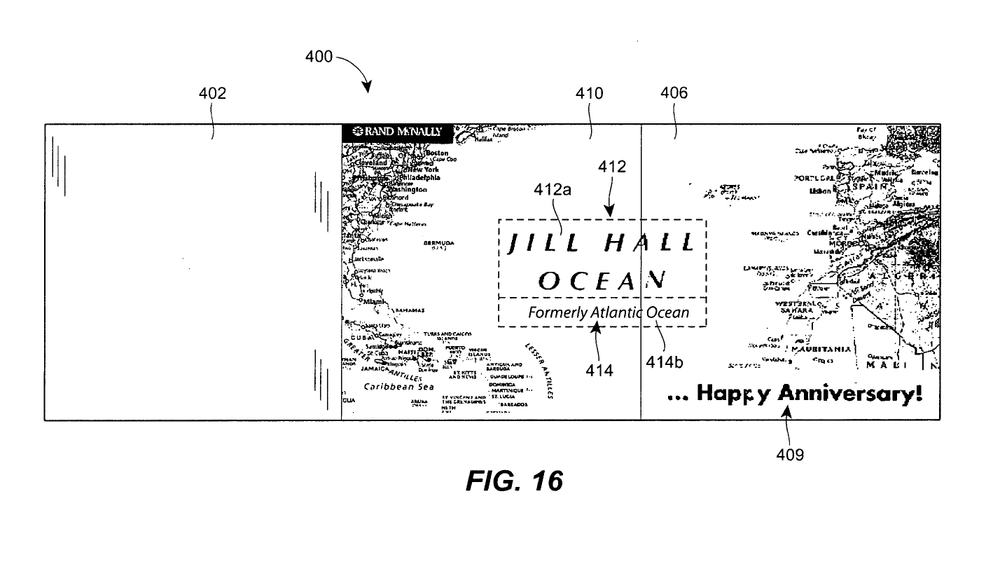

Referring now to FIGS. 14, 15 and 16, another exemplary greeting card 400 is shown. In the example of FIGS. 14-16 the greeting card 400 is a tri-fold card, as opposed to the bi-fold card of FIGS. 12 and 13. The greeting card 400 is printed on a substrate 402 and includes a number of areas, including an area 404 (shown on a face of the card in FIG. 14), an area 405 shown in FIG. 15 after opening the first panel of the card, and an area 406 shown on the interior of the card in FIG. 16 after opening another panel. The area 404 includes one or more messages or greetings, such as a message 408 printed on the area 404 as shown in FIG. 14, another message 407 printed on the area 405 in FIG. 15, and a message 409 printed on the area 406 of FIG. 16. As is also shown in FIG. 16, the area 406 includes a map insert 410. It will be understood that additional messages and/or additional map inserts may be provided as desired.

As shown in FIG. 16, the area 406 of the greeting card 400 includes a data field 412 corresponding to the area highlighted in, for example, FIGS. 9 and 10 using the detail box 225. This data field 412 includes customized text 412a inserted by the user as described above. The customized text may be-recipient-specific indicia such as, for example, “Jill Hall Ocean” instead of the original location-specific map indicia (i.e., “Atlantic Ocean”). Another data field 414 may be provided. In the disclosed example, the data field 414 is disposed on the substrate 402 immediately adjacent to or below the data field 412. In a sample shown, the data field 414 refers to the original location-specific map indicia 414b that would normally occupy the data field 412. Specifically, the term “formerly Atlantic Ocean” makes reference to the fact that the term “Jill Hall Ocean” now occupies the data field that would, in a conventional map, say “Atlantic Ocean.” Thus, the information in the data field 412 is specified by the user and, in accordance with the disclosed example, the information in the data field 412 may be specific to a recipient of the card (i.e., the recipient of the card presumably has the name “Jill Hall”).

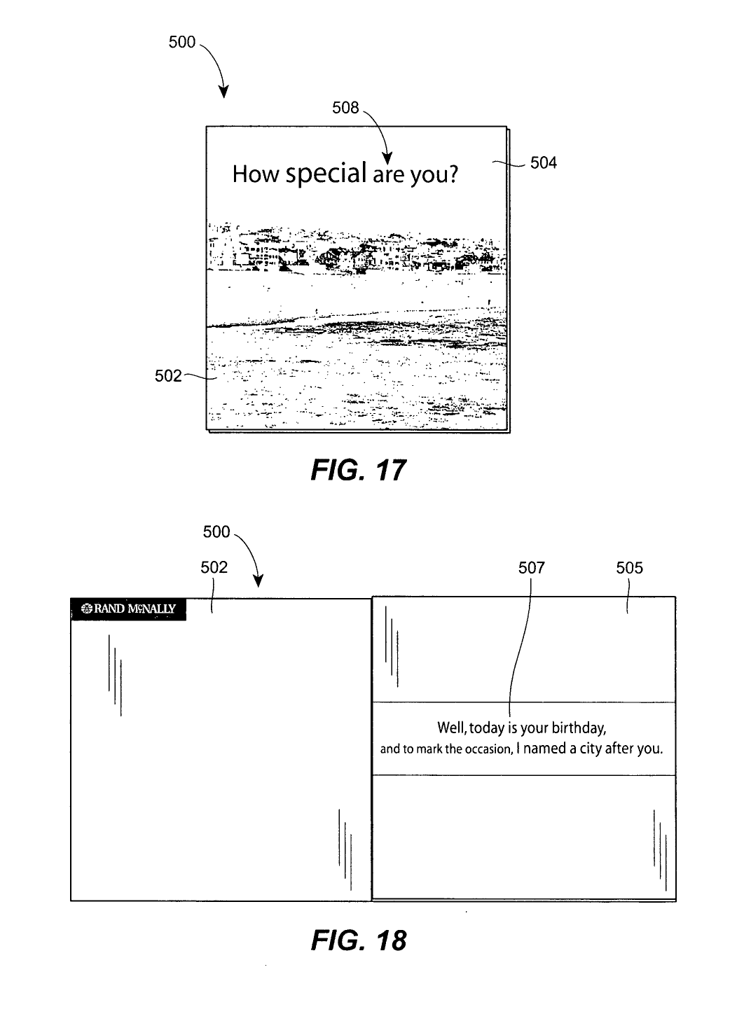

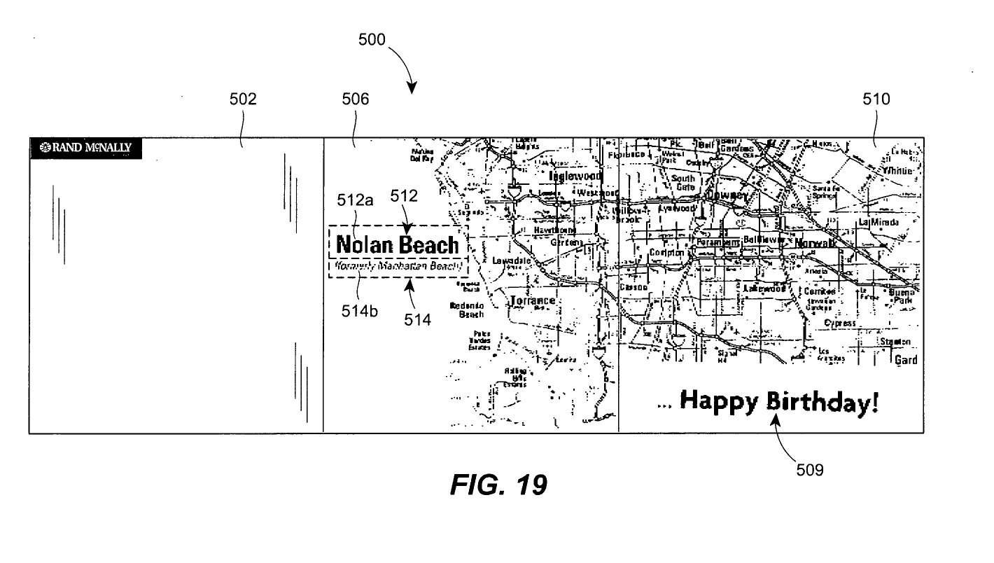

Referring now to FIGS. 17, 18 and 19, another exemplary greeting card 500 is shown. In the example of FIGS. 17-19 the greeting card 500 is again a tri-fold card. The greeting card 500 is printed on a substrate 502 and includes a number of areas, including an area 504 (shown on a face of the card in FIG. 17), an area 505 shown in FIG. 18 after opening the first panel of the card, and an area 506 shown on the interior of the card in FIG. 19 after opening another panel. The area 504 includes one or more messages or greetings, such as a message 508 printed on the area 504 as shown in FIG. 17, another message 507 printed on the area 505 in FIG. 18, and a message 509 printed on the area 506 of FIG. 19. As is also shown in FIG. 19, the area 506 includes a map insert 510. It will be understood that additional messages and/or additional map inserts may be provided as desired.

As shown in FIG. 19, the area 506 of the greeting card 500 includes a data field 512 corresponding to the area highlighted in, for example, FIGS. 9 and 10 using the detail box 225. This data field 512 includes customized text 512a inserted by the user as described above. The customized text may be recipient-specific indicia such as, for example, “Nolan Beach” instead of the original location-specific map indicia (i.e., “Manhattan Beach”). Another data field 514 may be provided. In the disclosed example, the data field 514 is disposed on the substrate 502 immediately adjacent to or below the data field 512. In a sample shown, the data field 514 refers to the original location-specific map indicia 514b that would normally occupy the data field 512. Specifically, the term “formerly Manhattan Beach” makes reference to the fact that the term “Nolan Beach” now occupies the data field that would, in a conventional map, say “Manhattan Beach.” Thus, the information in the data field 512 is specified by the user and, in accordance with the disclosed example, the information in the data field 512 may be specific to a recipient of the card (i.e., the recipient of the card presumably has the name of “Nolan”).

Using the electronic greeting card printing and/or display system described herein, a user may select, design and customize a greeting card to be printed, e-mailed, or displayed for the user according to the user's needs in a manner that enables the user to visualize the greeting at both a low level of detail or resolution and a high level of detail or resolution during the design process. This process also allows the user to preview the greeting card by viewing the greeting card on the user interface with the user added features, such as a title, scale, marked location(s), page numbers and grid lines, etc.

Of course, while the electronic greeting card design and printing system 10 described herein is described as using particular types of servers, particular file formats and communication programs, other software and hardware and other types of file and communication formats may be used instead of or in addition to those described herein to implement this system.

Additionally, it will be appreciated that a number of possible greeting designs may be used, such as, for example, portrait cards, landscape cards, bi-fold cards, tri-fold cards, postcards, etc. In addition to the areas, data fields, and messages shown, the greeting card may include additional areas, data fields, and/or messages as desired. It will be appreciated that any of the above exemplary greeting cards may also be displayed on a display, as opposed to being printed on a substrate.

Moreover, while the greeting card design program and associated components described herein are preferably implemented in software stored in and executed in, for example, a server or other computer, they may alternatively or additionally be implemented in other hardware, firmware, etc., as desired. If implemented in software, the programs described herein may be stored in any computer readable memory such as on a magnetic disk, a laser disk, or other storage medium, in a RAM or ROM of a computer, etc. Likewise, this software may be delivered to a user or a device via any known or desired delivery method including, for example, over a communication channel such as a telephone line, the Internet, etc. Also, while the map and greeting card design programs and the design and printing system 10 are described in detail to be used in conjunction with a public communication network, it should be noted this program and system could be used in other environments, including communication environments not accessible by the public.

Using the electronic greeting printing and/or display system described herein, a user may select, design and customize a greeting card having a map insert in accordance with the user's needs in a manner that enables the user to visualize the greeting to be printed or displayed. In particular, the greeting card design and printing/display system 10 described herein provides a produce-to-order, customer defined greeting card that is created using fully automated online computer technology in which the customer may select or design the card content, the map insert, delivery options, customized icons, symbols, colors, and fonts, customized points, lines, polygons and other printed elements, etc., resulting in a printable or displayable file to be sent to a remote location via an automated procedure. Furthermore, because the greeting card is created using the same data used to create other published greeting cards and maps, the greeting card and the map insert in the card is capable of visually matching the “look and feel” of printed greeting cards and maps sold via, for example, standard commercial retail distribution channels.

A more detailed explanation of the steps pertaining to the creation of the map or map insert can be found in co-pending and commonly owned U.S. patent application Ser. No. 10/057,962, entitled Customized Wall Map Printing System, the entire disclosure of which is incorporated herein by reference.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

We claim:

1. A system for creating a customized greeting card for a recipient comprising:
a computer readable memory;
a map database that stores map data pertaining to a plurality of geographic locations, each of the plurality of geographic locations including a plurality of location-specific indicia;
a first routine stored on the computer readable memory and adapted to be executed on a processor to access the map database to obtain map data pertaining to a selected geographic location;
a second routine stored on the computer readable memory and adapted to be executed on a processor to display on a user interface the map data, the map data including location-specific indicia for the selected geographic location;
a third routine stored on the computer readable memory and adapted to be executed on a processor to display on the user interface an electronic greeting card depicting the selected geographic location; and
a fourth routine stored on the computer readable memory and adapted to be executed on a processor to enable the user to add customized indicia to permit the customized indicia to be displayed on the electronic greeting card.

2. The customized greeting card system of claim 1, including a fifth routine arranged to forward the electronic greeting card to a printer, the printer arranged to print the electronic greeting card on a substrate.

3. The customized greeting card of claim 2, including a sixth routine arranged to permit the user to select the printer from a plurality of printers.

4. The customized greeting card of claim 3, wherein the sixth routine is arranged to permit the user to select the printer based on a location of the printer.

5. The customized greeting card system of claim 1, including a fifth routine arranged to transmit the electronic greeting card to a recipient.

6. The customized greeting card system of claim 5, wherein the fifth routine is arranged to wirelessly transmit the electronic greeting card to the recipient.

7. The customized greeting card system of claim 5, wherein the fifth routine is arranged to transmit the electronic greeting card to the recipient via the internet.

8. The customized greeting card system of claim 2, wherein the first routine includes a selection routine arranged to enable the user to select the selected geographic location.

9. The customized greeting card system of claim 8, wherein the selection routine is based at least in part on an address input by the user.

10. The customized greeting card system of claim 1, wherein the fourth routine further enables the user to change at least a portion of the location-specific indicia to recipient-specific indicia.

11. The customized greeting card system of claim 10, wherein the fourth routine displays on the electronic greeting card the unchanged location-specific indicia.

12. The customized greeting card system of claim 1, including a greeting card database that stores greeting card data pertaining to a plurality of greeting card templates, and further including a fifth routine and a sixth routine, the fifth routine stored on the computer readable memory and adapted to be executed on a processor to access the greeting card database to obtain greeting card data pertaining to a selected greeting card template, the sixth routine stored on the computer readable memory and adapted to be executed by the processor, the sixth routine adapted to enable the user to select the electronic greeting card from the greeting card database.

13. The customized greeting card system of claim 12, wherein the fifth routine is adapted to enable the user to select one or more greeting card characteristics from a set of possible greeting card characteristics.

14. The customized greeting card system of claim 13, wherein the fifth routine is adapted to enable the user to select a substrate size, and another routine arranged to enable the user to print the electronic greeting card at a printer.

15. The customized greeting card system of claim 1, including a fifth routine stored on the computer readable memory and adapted to be executed on a processor to enable the user to add indicia to the electronic greeting card.

16. The customized greeting card system of claim 1, wherein the second routine is adapted to enable the user to select a map characteristic from a set of possible map characteristics.

17. The customized greeting card system of claim 16, wherein the second routine is adapted to permit the user to select a map scale from the set of possible map characteristics.

18. The customized greeting card system of claim 1, including a fifth routine stored on the computer readable memory and adapted to be executed on a processor to enable a user to select a print feature to be used to print the electronic greeting card on a substrate, the print feature including specifying a location of a print facility, an orientation of the electronic greeting card with respect to a substrate, or a physical size of the substrate.

19. The customized greeting card system of claim 18, wherein the fifth routine is adapted to enable the user to select a print facility from a list of possible print facilities.

20. A system for creating a greeting card comprising:
a computer readable memory;
a map database that stores map data pertaining to a plurality of geographic locations, each of the plurality of geographic locations including a plurality of location-specific indicia;
a first routine stored on the computer readable memory and adapted to be executed on a processor to access the map database to obtain map data pertaining to a selected geographic location;
a second routine stored on the computer readable memory and adapted to be executed on a processor to display on a user interface the selected geographic location and the location-specific indicia for the selected geographic location;
a third routine stored on the computer readable memory and adapted to be executed on a processor to enable the user to change selected location-specific indicia to a customized indicia;
a fourth routine stored on the computer readable memory and adapted to be executed on a processor to enable the user to display on the user interface an electronic greeting card depicting the map data for the selected geographic location and including the customized indicia.

21. The customized greeting card system of claim 20, wherein the fourth routine displays on the electronic greeting card the original selected location-specific indicia adjacent the customized indicia.

22. The customized greeting card system of claim 21, wherein the electronic greeting card is printable on a substrate.

23. The customized greeting card system of claim 20, including a fifth routine adapted to display on the user interface a list of possible print facilities and to enable the user to select one of the possible print facilities from the list of possible print facilities as the print facility to use to print the electronic greeting card on a substrate.

24. The customized greeting card system of claim 20, including a fifth routine stored on the computer readable memory and adapted to be executed on a processor to enable the user to add indicia to the electronic greeting card.

25. The customized greeting card system of claim 20, wherein the second routine is adapted to enable the user to change map characteristics of the selected geographic location.

26. A system for creating a customized greeting card comprising:
a user interface, the user interface arranged to permit a user to obtain map data pertaining to a geographic location from a map database that stores map data pertaining to a geographic location, the user interface further arranged to permit the user to customize location-specific indicia for the geographic location, the user interface further arranged to permit the user to obtain greeting card data from a greeting card database that stores data pertaining to a greeting card;
a controller operatively coupled to the user interface, the controller further operatively coupled to an electronic display, the controller operatively coupled to the map database, and the controller operatively coupled to the greeting card database, the controller arranged to obtain map data from the map database and to obtain greeting card data from the greeting card database, the controller arranged to forward the obtained map data and the obtained greeting card data to the user interface for display, the controller further arranged to permit the user to customize the selected map data on the display or to customize to greeting card data on the display; and
the controller arranged to produce a greeting card output file including greeting card data and a map insert for insertion in the display of the greeting card.

27. The system of claim 26, wherein the user interface is operatively coupled to a kiosk.

28. The system of claim 26, including a printer, and wherein the output file is communicated to the printer for printing.

29. The system of claim 26, including a user display, and wherein the output file is electronically communicated to the user display via the internet or via a wireless connection.

30. The system of claim 29, wherein the user display is a cell phone or a personal digital assistant.

31. The system of claim 26, including a GPS link, the GPS link arranged to acquire a location and to communicate the location to the controller, the controller arranged to select map data pertaining to the acquired location.

32. A greeting card created by a user and comprising:
a printable substrate;
the substrate including a first area containing a greeting directed to a recipient;
the substrate including a second area containing a map, the second area including a plurality of data fields including location-specific map indicia; and
the substrate including a third area, the third area corresponding to one of the data fields of the second area, the third area containing user-specified indicia substituted for user-selected location-specific indicia.

33. The greeting card of claim 32, including a fourth area adjacent the third area, the fourth area including indicia indicating that a selected one of the data fields of the second area has been edited to include the user-specified indicia.

34. The greeting card of claim 32, wherein the user-specified indicia comprises recipient-specific indicia.

35. The greeting card of claim 32, including a fourth area, the fourth area including indicia indicating that original location-specific indicia corresponding to one of the data fields has been edited to include the user-specified information.

36. The greeting card of claim 35, wherein the fourth area is adjacent the third area.

37. A system for displaying a greeting card created by a user for presentation to a recipient, the system comprising:
a display capable of displaying a depiction of a greeting card;
the display including a first area containing a greeting directed to a recipient;
the display including a second area containing a map, the second area including a plurality of data fields including location-specific map indicia; and
the display including a third area, the third area corresponding to one of the data fields of the second area, the third area containing user-specified indicia.

38. The greeting card of claim 37, including a fourth area adjacent the third area, the fourth area including indicia indicating that a selected one of the data fields of the second area includes the user-specified indicia substituted for user-selected location-specific map indicia.

39. The greeting card of claim 37, wherein the user-specified indicia comprises recipient-specific indicia.

40. The greeting card of claim 37, including a fourth area, the fourth area including indicia indicating that original location-specific map indicia corresponding to one of the data fields has been edited to include the user-specified information.

41. The greeting card of claim 40, wherein the fourth area is adjacent the third area.

42. The greeting card of claim 37, wherein the display comprises a printable substrate.

43. The greeting card of claim 37, wherein the display comprises an electronic display.

44. The greeting card of claim 37, wherein the display is carried by a personal digital assistant.

45. A method of permitting the creation of a customized greeting card comprising the steps of:
providing a user interface, the user interface arranged to permit a user to greeting card data from a greeting card database that stores greeting card data, the user interface further arranged to obtain map data pertaining to a geographic location from a map database that stores map data pertaining to a geographic location, the user interface further arranged to permit the user to customize location-specific indicia for the geographic location;
a controller operatively coupled to the user interface, the controller further operatively coupled to each of an electronic display, the map database, and the greeting card database, the controller arranged to obtain map data from the map database and to obtain greeting card data from the greeting card database, the controller arranged to forward the obtained map data and the obtained greeting card data to the user interface for display, the controller further arranged to permit the user to customize the selected map data on the display or to customize to greeting card data on the display; and
the controller arranged to produce a greeting card output file including greeting card data and a map insert for insertion in the display of the greeting card.
